(19) United States
(12) Patent Application Publication
(10) Pub. No.: US 2005/0176546 A1
(43) Pub. Date: Aug. 11, 2005

(54) Drive device for motor vehicle

(75) Inventors: Yasuhiko Fujita, Moriyama-shi (JP); Hiroki Mori, Hirakata-shi (JP); Takayuki Saka, Neyagawa-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 11/037,360

(22) Filed: Jan. 19, 2005

(30) Foreign Application Priority Data
Feb. 9, 2004 (JP) 2004-032578

(51) Int. Cl. F16H 48/26

(52) U.S. Cl. 475/150

(57) ABSTRACT

A drive device of a motor vehicle includes a reduction device coupled to a drive shaft of an SR motor, a differential device coupled to a reduction output shaft of the reduction device, a pair of differential output shafts respectively extending left and right from the differential device, and a pair of wheels respectively coupled to the differential output shafts.

### BACKGROUND OF THE INVENTION

1. Field of the Invention

The present invention relates to a drive device of a vehicle driven by an electric motor.

2. Background Information

In general, internal combustion engines are employed as drive devices of vehicles. In recent years, however, environmental issues have been highlighted so that attention has been focused on electric cars, which can reduce atmospheric pollution due to emissions as well as noise. Since an electric car uses an electric motor that employs electric power for driving as its power source, it does not discharge emissions, and produces less noise than the internal combustion engine. Therefore, not only in the automotive field, but also in the field of forklift trucks and other fields which conventionally employ both internal combustion engines and electric motors as drive devices, the rate at which electric motors are adopted has been increasing year after year for the purpose of improving the environment.

A drive device of a motor vehicle such as a forklift truck generally has a structure in which a reduction gear or device reduces the speed of rotation of a motor, and transmits the rotation thus reduced in speed from a reduction output shaft to a differential gear or device, and the rotation is then transmitted from a differential output shaft of the differential device to respective drive wheels. If the motor and reduction device are arranged in positions radially shifted from the differential output shaft, the electric motor and reduction device will occupy a large space, and thus increase the size and weight of the drive device itself. In an automobile, the drive device bears a part of the weight of the vehicle. In the forklift truck, the drive device bears a part of the weight of the vehicle, and further bears the weight of a movable fork unit used to carry loads as well as a weight of the load itself. Therefore, these drive devices bear large loads. For the purpose of reducing sizes and weights, therefore, a coaxial type of technique has been devised. In this technique, a planetary gear drive is employed as a reduction device, and thus the drive shaft of an electric motor is arranged coaxial to a reduction output shaft of a reduction device and a differential output shaft.

DC or AC motors are typically employed as electric motors. A DC motor cannot produce a large torque at a high speed, and an AC motor has a large body relative to its torque. Therefore, large electric motors and thus large drive devices are often employed for obtaining required torque.

Since the DC motor has a coil wound around a rotor, the rotor generates heat due to current flowing through the coil. The heat of the rotor may be undesirably transmitted to the drive device and electric motor body and thus may damage the coil.

In view of the above, there exists a need for a drive device which overcomes the above mentioned problems in the prior art by using an SR motor. This invention addresses this need in the prior art as well as other needs, which will become apparent to those skilled in the art from this disclosure.

### SUMMARY OF THE INVENTION

In one aspect of the present invention, a drive device of a motor vehicle includes a motor, a reduction device coupled to a drive shaft of the motor, a differential device coupled to a reduction output shaft of the reduction device, a pair of differential output shafts respectively extending from the differential device, and a pair of wheels respectively coupled to the differential output shafts. The motor is an SR motor.

Since this drive device employs an SR motor as its motor, it can produce a high torque in a low speed range, and can have a reduced size. Since the SR motor generates heat from its stator side, the drive shaft and bearings do not generate heat, and thus the motor can be easily cooled.

In another aspect of the present invention, the drive shaft is coaxial to the differential output shaft. In this drive device, since the drive shaft is coaxial to the differential output shaft, the motor does not protrude sideways with respect to the differential output shaft, and thus the device can be reduced in size.

In yet another aspect of the present invention, the reduction device is comprised of a planetary gear drive. Since a planetary gear drive is employed in the reduction device, the reduction device can be arranged coaxial to the drive shaft.

In yet another aspect of the present invention, the differential device is comprised of a planetary gear drive. Since a planetary gear drive is employed in the differential device, the differential device can be arranged coaxial to the drive shaft.

In yet another aspect of the present invention, the motor vehicle is a forklift truck.

The drive device according to the present invention can be small in size, and can easily cool the motor.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows the structure of a drive device of a motor vehicle; and

FIG. 2 shows an axial cross-section of a motor when an SR motor is employed.

### DETAILED DESCRIPTION OF THE PREFERRED EMBODIMENTS

Embodiments of the invention will now be described with reference to the drawings.

(1) Structure of the Drive Device of a Motor Vehicle

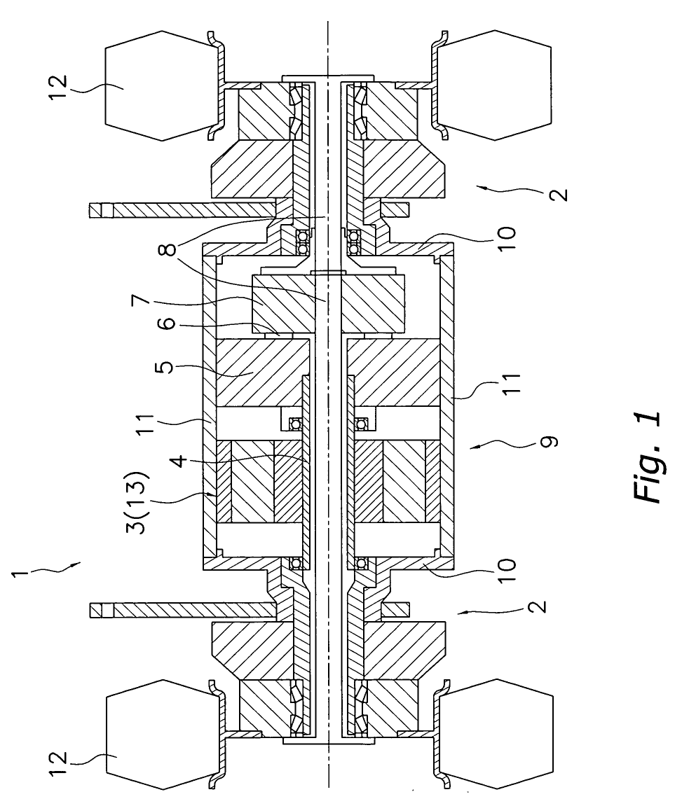

The structure of a drive device of a motor vehicle will now be described. FIG. 1 shows the structure of the drive device of the motor vehicle. A drive device 1 of the motor vehicle is primarily formed of an electric motor 3, a reduction device 5, a differential device 7, shaft support mechanisms 2, wheels 12 and a housing 9. The electric motor 3 is the power source of the vehicle, and drives a drive shaft 4 by means of electric power. The drive shaft 4 extends left and right from the motor 3. The drive shaft 4 is formed of a hollow cylindrical member, and has one end coupled to the reduction device 5.

The reduction device 5 is provided in order to reduce the rotation speed of the drive shaft 4, and includes a planetary gear drive. A reduction output shaft 6 of the reduction device 5 is coupled to the differential device 7 to transmit the rotation, the speed of which has been reduced by the reduction device 5, to the differential device 7. The differential device 7 transmits the rotation of the reduction output shaft 6 to each of the left and right wheels 12 independently of the other. Two differential output shafts 8 extend from the differential device 7 toward the left and right wheels 12, respectively. One of the differential output shafts 8 extends coaxially through the reduction device 5 and the drive shaft 4. The wheels 12 are annular members, and are arranged on the opposite ends of the drive device 1, respectively. Each wheel 12 has a radially inner portion non-rotatably fixed to an end of the corresponding differential output shaft 8 in order to receive the rotation of the differential output shaft 8.

The housing 9 covers the motor 3, reduction device 5 and differential device 7, and the motor 3 and reduction device 5 are fixed inside the housing 9. The differential device 7 is rotatably supported by a bearing arranged around it. The housing 9 is formed of a pair of axle brackets 10 and a casing 11. The casing 11 is arranged between the paired axle brackets 10, and is fixed to each axle bracket 10.

The axle brackets 10 are arranged around portions of the differential output shaft 8 extending from the motor 3 toward the left and right wheels 12 through the housing 9, respectively. The shaft support mechanisms 2 extend through the axle brackets 10 in order to coaxially position the axle brackets 10, differential output shaft 8 and wheels 12. Each shaft support mechanism 2 is internally provided with a bearing, which rotatably supports an end of the drive shaft 4 and an end of the differential output shaft 8. Owing to the above structures, the housing 9, wheels 12 and shaft support mechanisms 2 can bear the weight of the vehicle and the like while transmitting the rotation produced by the motor 3 to the wheels 12.

(2) Structure of the Motor

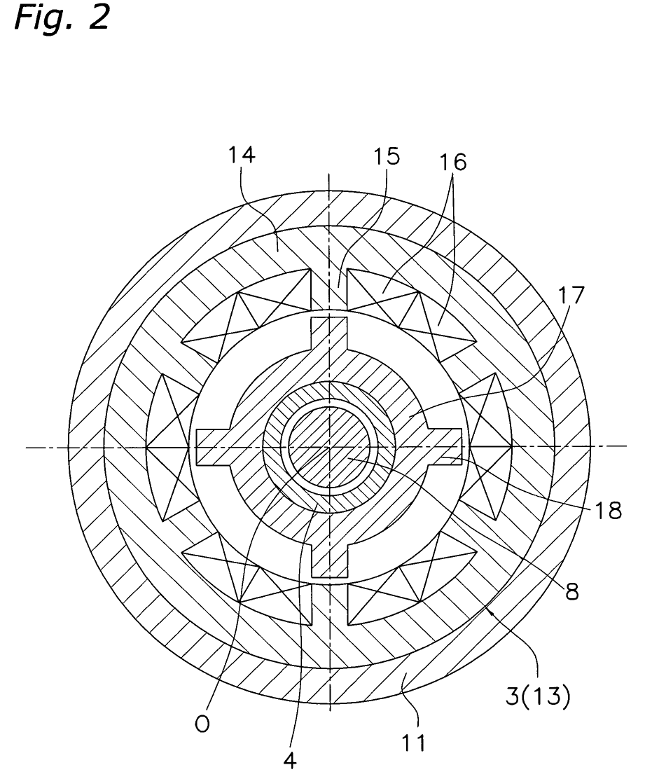

The present invention employs an SR motor as the motor of the drive device described above. FIG. 2 shows by way of example an axial cross-section of the motor employing the SR motor. The SR motor 13 is primarily formed of a stator 14 and a rotor 17. The stator 14 is a cylindrical member, and has an outer periphery non-rotatably fixed to the casing 11. The stator 14 is provided at its inner periphery with a plurality of circumferentially spaced salient poles 15, which protrude radially inward. Each salient pole 15 is an axially extending plate-like member, and a coil 16 is wound around a radial axis. A power source such as a battery in the vehicle can energize the coil 16.

The rotor 17 is a cylindrical member formed of a magnetic material, and is non-rotatably fixed around the drive shaft 4. The rotor 17 is provided at its outer periphery with a plurality of circumferentially spaced projections 18, which project radially outward. Each projection 18 is a plate-like member extending axially. Rotor 17 is rotatably arranged inside the stator 14. More specifically, the rotor 17 is rotatably supported while maintaining a minute space between the outer peripheral surfaces of the projections 18 and the inner peripheral surfaces of the salient poles 15 and coils 16 in order to prevent contact therewith. FIG. 2 shows an example in which the salient poles 15 of the stator 14 form a three-phase six-pole stator and a four-pole rotor is employed.

(3) Operation

The operation of the SR motor will now be described. The SR motor 13 supplies a current to the coils 16 around the salient poles 15 of stator 14 according to position information of the rotor 17, and produces rotational motion by means of a magnetic attractive force which is continuously generated by the salient poles 15. More specifically, when the opposed salient poles 15 of the stator 14 are energized, a magnetic force is produced so that one of the salient poles 15 of the stator 14 pulls one of the projections 18 of the rotor 17, and the other salient pole 15 of the stator 14 pulls another projection 18 of the rotor 17. This generates torque. When the projections 18 of the rotor 17 completely overlap with the salient poles 15 of the stator 14, the magnetic circuit has a minimum reluctance so that the attractive forces occur only in the radial direction, and no torque is generated. After this state, the current will be supplied to the new coils 16 in the opposed positions, which are shifted reversely in the rotor rotating direction from the currently energized coils 16, and thus the salient poles 15 will produce magnetic force. The magnetic force thus produced pulls the projections 18 neighboring to the salient poles 15 producing the magnetic force so that the rotor 17 rotates in one direction. In this manner, the coils 16 to be energized are changed in the direction opposite to the rotating direction of the rotor 17. As described above, the rotor 17 is rotated by successively changing the positions of the coils 16 to be energized.

The SR motor 13 differs from DC and AC motors in the following points. In a DC motor, an energized coil is located within a magnetic field, and a rotor is rotated by utilizing an electromagnetic force produced by the coils. In an AC motor, an alternating current produces a rotating magnetic field, and the rotor is rotated by utilizing an electromagnetic force produced by electromagnetic induction. However, the SR motor 13 rotates the rotor 17 by utilizing the magnetic attractive force produced by energizing the coils 16.

In general, the DC motor controls its rotation speed and torque by means of voltage and current. In a low speed range, therefore, the electromagnetic force is large, and a high torque is produced. In a high speed range, however, the electromagnetic force is small, and therefore the torque produced is small. The AC motor produces a smaller torque than the DC motor, and the rotation speed and the torque are controlled by frequency and current, respectively, so that controllability results in an increase in cost. Since the torque is small, one must select a motor having a large size.

With the SR motor 13 (the motor 3 of the present invention), the rotation speed can be adjusted by changing the timing at which the coils 16 are energized and de-energized, and the torque can be adjusted by means of current so that the rotation speed and the torque can be controlled independently of each other. In particular, a high torque can be produced by passing a large current in a low speed range so that a small motor can be selected, in contrast to AC and DC motors, which must have large sizes due to the torque often required in the low speed ranges of vehicles.

In general, since the DC motor has a coil wound around the rotor, the rotor will generate heat when current flows through the coil. Since the heat generated from the rotor is transferred to the motor body, a fan is attached to the rotor for externally air-cooling the stator by utilizing the rotation of the rotor. However, it is difficult in view of the structure to cool the rotor itself, which generates the heat, and thus the drive shaft fixed to the rotor and the bearing will be heated by the heat transmitted thereto and in turn the entire drive device will be heated. High motor body is not preferable because it may damage the coil.

However, with the SR motor 13 (the motor 3 of the present invention), the coils 16 are wound around the stator 14 so that the rotor 17 does not generate heat, and heat will not transmitted via the drive shaft, bearing and the like. Although the stator 14 generates heat from the coils 16, the motor 3 can be cooled more easily than when the rotor 17 generates heat.

(4) Cooling Effect

The operation and effects of the present invention can be summarized as follows.

Since the SR motor 13 is employed as the motor 3, the motor 3 can generate high torque in a low speed range, and a motor 3 having a comparatively small size can be selected so as to reduce the size of the drive device 1. In the SR motor 13, heat is generated on the stator side, and the drive shaft 4 and bearing do not generate heat, and thus the motor 3 can be cooled easily. Since the drive shaft is coaxial to the differential output shaft 8, the motor 3 does not protrude sideways with respect to the differential output shaft 8, and thus the device can be reduced in size.

Since planetary gear drives are employed as the reduction device 5 and the differential device 7, the reduction device 5 and the differential device 7 can be arranged coaxially to the drive shaft.

(5) Other Embodiments

The present invention is not limited to the aforementioned embodiment, and various changes and modifications can be made thereto that are within the spirit and scope of the present invention. For example, in the aforementioned embodiment, a six-poles stator and a four-poles rotor are employed. However, the numbers of poles is not limited to the above values. Although the salient poles 15 and the projections 18 are circumferentially equally spaced, these may be spaced unequally.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A drive device for a motor vehicle comprising:
a motor;
a reduction device coupled to a drive shaft of the motor;
a differential device coupled to a reduction output shaft of the reduction device;
a pair of differential output shafts respectively extending from the differential device; and
a pair of wheels respectively coupled to the differential output shafts;
wherein the motor is an SR motor.

2. The drive device according to claim 1, wherein the drive shaft is coaxial to the differential output shaft.

3. The drive device according to claim 1, wherein the reduction device is comprised of a planetary gear drive.

4. The drive device according to claim 1, wherein the differential device is comprised of a planetary gear drive.

5. The drive device according to claim 1, wherein the motor vehicle is a forklift truck.
